(19) United States
(12) Patent Application Publication
(10) Pub. No.: US 2009/0238925 A1
(43) Pub. Date: Sep. 24, 2009

(54) Starch and Amphiphilic Surfactant or Particulate Emulsion for Paper Coating Applications

(76) Inventors: Shiji Shen, Forsyth, IL (US); Penelope A. Patton, Decatur, IL (US); Meggan Hostetler-Schrock, Forsyth, IL (US); Michael D. Harrison, Decatur, IL (US)

Correspondence Address: WILLIAMS, MORGAN & AMERSON, P.C., 10333 RICHMOND, SUITE 1100, HOUSTON, TX, 77042, US

(21) Appl. No.: 12/328,990

(22) Filed: Dec. 5, 2008

Related U.S. Application Data
(60) Provisional application No. 61/014,533, filed on Dec. 18, 2007.
(60) Provisional application No. 61/097,955, filed on Sep. 18, 2008.

(51) Int. Cl. D21H 19/54; C09D 103/02; B32B 9/06; B65D 85/00

(52) U.S. Cl. 426/106; 106/206.1; 106/210.1; 106/213.1; 106/215.3; 106/216.1; 524/47; 428/533; 428/486; 428/447

(57) ABSTRACT

A composition suitable for coating a paper product can comprise starch and at least one additional component selected from the group consisting of (a) an amphiphilic surfactant and (b) a particulate emulsion; wherein the weight ratio of surfactant to starch is from about 0.005:1 to about 0.25:1 and the weight ratio of the particulate emulsion to starch is from about 0.005:1 to about 0.429:1.

This application claims priority from U.S. provisional patent application Ser. No. 61/014,533, which was filed on Dec. 18, 2007, and U.S. provisional patent application Ser. No. 61/097,955, which was filed on Sep. 18, 2008, both of which are incorporated herein by reference.

### BACKGROUND OF THE INVENTION

The present invention relates generally to the fields of starch compositions. More particularly, it concerns starch compositions that impart oil or grease resistance when coated on paper products.

Fluorochemicals have been used to impart oil or grease resistance to paper or paperboard that is used to package oily or greasy foods, such as pet foods, microwaveable popcorn, pizza, fried potatoes, fried vegetables, pastries, chocolate bars, or foods containing oil-based sauces. However, there are various concerns regarding possible negative impacts of fluorochemicals on human health or the environment.

### SUMMARY OF THE INVENTION

One embodiment of the present invention is a composition comprising starch and at least one additional component selected from the group consisting of (a) amphiphilic surfactants, (b) particulate emulsions, and (c) combinations thereof, wherein, if the composition comprises one or more amphiphilic surfactants, the weight ratio of total surfactant to starch is from about 0.005:1 to about 0.25:1 and, if the composition comprises one or more particulate emulsions, the weight ratio of total particulate emulsion to starch is from about 0.005:1 to about 0.429:1. Thus, the composition can contain one or more amphiphilic surfactants, one or more particulate emulsions, or both.

Another embodiment of the invention is a paper product. The product comprises (a) a substrate that comprises paper and has a first surface and a second surface, and (b) a coating applied to at least part of the first surface of the substrate, wherein the coating comprises starch and at least one of an amphiphilic surfactant and a particulate emulsion. “Paper” is used herein to include both paper itself and stiffer paper products such as paperboard. The coating optionally can be applied to the entire first surface of the substrate, or to the second surface as well. A topcoat can be applied over the coating.

### DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 shows the effect of coating weight on water resistance for three compositions comprising starch, as described in Example 3.

### DESCRIPTION OF SPECIFIC EMBODIMENTS

In one embodiment, the present invention is a composition comprising starch and at least one additional component selected from the group consisting of (a) amphiphilic surfactants, (b) particulate emulsions, and (c) combinations thereof, wherein, if the composition comprises one or more amphiphilic surfactants, the weight ratio of total surfactant to starch is from about 0.005:1 to about 0.25:1 and, if the composition comprises one or more particulate emulsions, the weight ratio of total particulate emulsion to starch is from about 0.005:1 to about 0.429:1 The composition can contain an amphiphilic surfactant, a particulate emulsion, or both. The composition can be used for coating or “sizing” paper.

“Starch,” as used herein, encompasses materials known as starches or flours that can come from one or more of a variety of sources, such as corn, wheat, pea, potato, rice, tapioca, and others known in the industry. High amylose (e.g., containing at least about 40 wt % amylose) and chemically modified starches can be used. The starch can be substituted or unsubstituted. A combination of two or more types of starch can be used. In one embodiment, the starch is a waxy starch having an amylopectin content of at least about 95 wt %. Waxy corn starch is one suitable example. Dent corn starch is another suitable example.

In one embodiment, the starch is a thinned starch. “Thinned starch” means starch whose molecular weight has been reduced, for example by acid or chemical hydrolysis, enzymatic hydrolysis, mechanical forces or other means. One advantage of thinned starch is that an aqueous solution thereof can be applied to paper at a relatively high concentration while having a manageable viscosity.

Viscosity testing indirectly measures the average molecular weights of starch. The thinner the starch, i.e., the greater the reduction in polymer chain lengths in the starch as a result of the thinning technique, the higher the solids concentration of the starch that will be required to attain a given viscosity in aqueous solution. An exemplary starch is Cleer-Cote 625 (Tate & Lyle, Decatur, Ill.).

In some embodiments, an aqueous slurry of the starch will be cooked to gelatinize it. Suitable conditions for cooking the starch are known in the art. For example, starch can be cooked at a temperature from about 80° C. to about 200° C. for a time from about 5 min to about 60 min. Suitable apparatus that can be used for starch cooking includes open kettles and high-pressure jet cookers.

The amphiphilic surfactant and/or the particulate emulsion can be added to the starch, for example after the starch is cooked. It can also be added to a starch slurry prior to cooking or blended with dry starch, such as prior to slurrying the dry starch in water. For the surfactant, the sequence and timing of adding the ingredients is not critical. However, at least in some embodiments, the sequence can be important for the wax emulsion, especially at a temperature above its melting point.

The amount of surfactant and/or particulate emulsion can vary, depending on the exact properties desired for the composition. For example, in some embodiments, wherein the composition further comprises water, the aqueous starch composition can comprise from about 0.5 wt % to about 20 wt % surfactant, from about 2 wt % to about 10 wt % surfactant, or from about 4 wt % to about 5 wt % surfactant. (These percentages are based on the total weight of the aqueous composition.) One group of suitable surfactants is those that comprise a sulfate, phosphate, or carboxylate moiety, and an alkyl or alkenyl moiety having 4-24 carbons or an aromatic moiety having 6-24 carbons. Alkyl sulfates and alkyl disulfates are two classes of surfactants that could be used. One such surfactant that can be used in the present invention is sodium lauryl sulfate.

One example of a suitable particulate emulsion is an emulsion of paraffin wax. Various types of wax could be used, including synthetic and natural waxes like paraffin wax, beeswax, candellia wax, etc. In some embodiments, the composition comprises from about 0.5 wt % to about 30 wt %, from about 3 wt % to about 20 wt %, or from about 10 wt % to about 15 wt % paraffin wax.

In some embodiments, the weight ratio of surfactant to starch can be from about 0.005:1 to about 0.25:1, from about 0.02:1 to about 0.111:1, or from about 0.042:1 to about 0.053:1. In some embodiments, the weight ratio of wax or other particulate emulsion to starch can be from about 0.005:1 to about 0.429:1, from about 0.031:1 to about 0.25:1, or from about 0.111:1 to about 0.176:1.

In addition to the starch and the surfactant, the particulate emulsion, or both, the composition can further comprise other components. The composition can be an aqueous slurry, i.e., it can comprise water. In one embodiment, the composition comprises sufficient water have a solids content from about 3 wt % to about 40 wt % solids.

In the case of coated substrates, pinholing can be defined as the formation, in an applied coating layer during its drying or curing, of a plurality of small holes, smaller than 1 mm diameter, and typically from about 10 nm to about 100 microns in diameter, whose presence can permit oils, greases, or other substances to transit through the coating layer, whether from or to the substrate. Though not bound by theory, it is believed that pinholing may be caused by one or more factors such as incomplete coating-to-substrate contact, the presence of impurities, substrate surface defects, the inclusion of air bubbles in the coating, and the like. In one embodiment, the composition further comprises a defoamer. A defoamer may minimize pinholing of the composition when applied as a coating to a surface, as will be discussed below, or may enhance the performance of other materials added to the composition. Silicon-containing defoamers, such as Ivanhoe 1113A (Ivanhoe Industries, Inc., Zion, Ill.) or FG-10 (Dow Corning, Midland, Mich.), can be used. Alternatively, Bubreak series defoamers, such as Bubreak 4467 (Buckman Laboratories, Memphis, Tenn.), can be used. The defoamer or defoamers can be present from about 0.01 wt % to about 3 wt %, relative to the total solids (i.e., non-water) content of the composition.

In one embodiment, the composition further comprises a polymer selected from the group consisting of alginate, sodium carboxymethyl cellulose (CMC), and gelatin. Alginate, CMC, or gelatin can be useful when the composition is used as coating over which a topcoat is applied, or when high water resistance is desired, as will be discussed below.

In another embodiment, the composition further comprises a hydrophobic material, such as sodium stearate. The inclusion of sodium stearate or other hydrophobic materials can improve the water resistance of the composition.

In another embodiment, the composition further comprises a non-modified starch. A non-modified starch would be expected to slightly increase solution viscosity and reduce penetration rate after coating, leading to a lower minimum coat weight for forming flawless film. In one embodiment, the composition further comprises a sizing agent. A sizing agent can be useful when the composition is used as coating over which a topcoat is applied. An exemplary sizing agent is alkyl ketene dimer (AKD), which refers to a variety of 3-alkyl-4-alkylidene-2-oxetanones useful in paper sizing.

A representative AKD structure is:

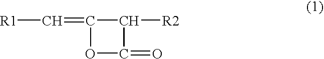

wherein each of R1 and R2 are independently any C12-C22 alkyl, C14-C20 alkyl, C14-C18 alkyl, or C14-C16 alkyl groups; even-numbered groups are considered particularly useful in some embodiments. Those AKDs obtainable by cycloaddition of one molecule of ketene R1-CH═C═O and one molecule of ketene R2-CH═C═O, by any cycloaddition process known useful therefor in the art, with R1 and R2 as defined above, can be employed herein, as can others, such as those described in U.S. Pat. No. 7,318,881 to Lindgren et al. and in patents cited therein. Useful AKDs are also commercially available, e.g., from the Paper Chemicals division of BASF AG (Ludwigshafen, Germany), from Kemira Pulp & Paper (Helsinki, Finland), or from Eka Chemicals, Inc. (Marietta, Ga., USA).

In one embodiment, the AKD is prepared from ketene derivatives of mixtures of fatty acids that comprise palmitic and/or stearic acids as the main component(s). Common ketenes used to prepare AKDs are palmitic and/or stearic acid-based ketenes, i.e. tetradecyl ketene and/or hexadecyl ketene, respectively. The tetradecyl ketene dimer is also referred to as palmitic ketene dimer, and the hexadecyl ketene dimer is also referred to as the steric ketene dimer; the combination diketene obtainable from one of each of these can be referred to as the “palmitic-stearic ketene dimer.” Since commercial AKD sizing is typically prepared from mixtures of palmitic and stearic ketene derivatives, it can and typically does comprise a mixture of all three of those dimers.

The starch composition can be used to coat various types of paper products, such as flexible sheets of paper or more rigid sheets of paperboard, for example. “Sizing” of paper is one example of the use of the starch composition for coating on a paper product.

The paper product comprises a substrate that comprises paper and has a first surface and a second surface (e.g., the opposite sides of a sheet of paper or paperboard). The paper product has a coating on at least part of the first surface of the substrate. The coating can comprise (or in some embodiments, consist essentially of) the ingredients described above, except that the coating process usually involves drying the starch composition after it is applied to the substrate, so the water content of the final coating will usually be substantially reduced. Optionally, the coating can be on the entire first surface of the substrate, and/or on all or part of the second surface as well.

In some embodiments, the aqueous starch composition that is applied to the substrate comprises about 3-40 wt % solids, or about 8-15 wt %. In some embodiments, the amount of the composition applied to the substrate ranges from about 0.1-50 gsm (grams per square meter), or about 3-10 gsm.

The coating can be applied to the substrate by any known technique. Exemplary techniques include, but are not limited to, use of a size press, tub, gate roll, spray applicator, calendar stack sizer, blade coater, or rod coater, among others. In one embodiment of the process, the starch composition is applied to the paper product in a “puddle” size press. For the starch composition to run well on this type of size press, its viscosity can be no greater than about 150 cps by Brookfield (100 rpm at 150° F., #2 spindle). For example, the viscosity of the composition can be about 25-150 cps, or, in some embodiments, 50-100 cps.

In one embodiment, the paper product forms all or part of a package that contains an oily or greasy food, and the coating stands between the oily or greasy food and the substrate. Thus, the coating can provide the package (e.g., a fast food wrapper) with an enhanced degree of resistance to penetration by grease or oil. Examples of oily or greasy foods that can be contained in the package include, but are not limited to, pet food, microwaveable popcorn, pizza, fried potatoes, fried vegetables, pastries, chocolate bars, and foods containing an oil-based sauce. Inclusion of a surfactant in the coating composition can improve the coating's ability to render the paper product grease-resistant.

Various embodiments of the present invention can provide a low cost coating for paper products that will give enhanced oil and grease hold-out. The compositions can be applied to paper product substrates using conventional size presses, thus avoiding the need for costly new equipment to be installed in a paper manufacturing facility.

Various embodiments of the present invention do not require the addition of protein (e.g., gelatin) or external plasticizers (e.g., sugars or low molecular weight polyols), which makes their production simpler and less expensive.

In one embodiment, the paper product further comprises a topcoat applied to at least part of the coating. Examples of such topcoats include (1) a silicone-containing film for release, (2) an oil-grease resistant film for optimum performance, (3) a water resistant film, and (4) a smooth and ink-adsorbing film for high quality printing, among others. In one embodiment, the topcoat is selected from the group consisting of the four exemplary topcoats stated above.

The properties of the coating are such that, when another formulation is top-coated onto the coating, the topcoating formulation will typically form a very smooth and uniform topcoat even with a low coat weight. Typically, if the topcoating formulation were coated directly onto the surface of paper, much higher coat weight would be required, an uneven film would form, or both. Such topcoats may be useful when the paper product is intended for liquid packaging, printing, or other uses in which water or solvent hold-out is desirable. Inclusion of a particulate emulsion in the coating composition can improve the coating's ability to render the paper product water-resistant.

Certain embodiments of the invention can be further understood from the following examples.

### Example 1

Two types of starch were slurried in water to a concentration of about 22 wt %: Stay Size 100, an octenyl-succinated, thinned waxy corn starch, and Cleer-Cote 625, an unsubstituted, thinned waxy corn starch (both available from Tate & Lyle, Decatur, Ill.). The starch slurries were cooked using a bench-top jet cooker at about 286° F. The flow rate through the jet cooker was about 200 ml/min, which gave retention time of the paste in the tail line of about 1 minute. The final paste solids concentrations were measured using a refractometer.

Sodium lauryl sulfate (SLS; obtained from Stephan) and/or paraffin wax emulsion (from Blended Wax, Inc.) were added to some of the samples in the amounts shown in Table 1. Water was added to the samples as needed to attain 15% by weight total solids. After the appropriate amount of water and additives, if any, were added to the starch solutions, they were mixed until uniform with an overhead stirrer. The starch solutions were placed in a heated water bath and maintained at 150° F., with constant overhead stirring. The viscosity of the coating solutions was measured by a Brookfield DV-E viscometer at 150° F. and 100 rpm using spindle #2.

The solutions were coated on Boise 25 pound paper with a K 303 Multi-Coater (RK Coat Instruments, UK). The coating weights used are listed in Table 1. The coated paper was held at 23° C. and 45% relative humidity overnight.

The resistance of the coated paper to grease and oil was measured using Tappi Test Method 559 CM-02, also commonly referred to as the 3M Kit test. The procedure was generally as follows: Each sheet of paper to be tested was placed on a clean, flat surface, with care taken not to touch the area to be tested. On the test area was dropped, from a height of about 2.5 cm, a drop of test solution with a disposable pipette from an intermediate Kit Number bottle. A stopwatch was started as the drop was applied. After 15 seconds, excess fluid was removed with a clean absorbent paper towel and the wetted area was examined. Failure was evidenced by pronounced darkening of the specimen caused by penetration, even in a small area, under the drop. The procedure was repeated as required, making sure that drops from succeeding Kit Number bottles fell in untouched areas. Results were reported as the Kit Value, which is the highest numbered solution (1-12) that stood on the surface of the specimen for 15 seconds without causing failure. A higher value on this test indicates greater resistance to grease and oil.

Table 1 lists the starch solutions tested and the results obtained. The 3M kit values in the table are averages of multiple tests.

TABLE 1

| | | | | 3M Kit Value | | | |
|---|---|---|---|---|---|---|---|
| | Additive | | | | | 4 lb/ | |
| Starch | (wt %) | | Viscosity | 9 lb/ | 6 lb/ | 3000 | 3 lb/ |
| type | SLS | wax | (cps) | 3000 ft² | 3000 ft² | ft² | 3000 ft² |
| Stay Size | — | — | 110-125 | 7 | 6 | 0-4 | 0-0.5 |
| 100 | | | | | | | |
| Cleer-Cote | — | — | 110-121 | 7 | 5-6 | 0 | 0 |
| 625 | | | | | | | |
| Cleer-Cote | 2 | — | 95-105 | 7 | 7 | 3-4 | 0 |
| 625 | | | | | | | |
| Cleer-Cote | 3 | — | 98-109 | — | 7 | 6 | 1-2 |
| 625 | | | | | | | |
| Cleer-Cote | 5 | — | 94-108 | — | 9 | 7 | 3-5 |
| 625 | | | | | | | |
| Cleer-Cote | — | 10 | 96-100 | 10 | 6-7 | 0-1 | 0 |
| 625 | | | | | | | |
| Cleer-Cote | 2 | 10 | 97-103 | — | 5-6 | 4-5 | 1-2 |
| 625 | | | | | | | |

SLS, sodium lauryl sulfate.

The compositions of thinned waxy starch with additives performed better than the octenyl-succinated starch composition.

### Example 2

Ethylex 2025 starch, a thinned, hydroxyethylated dent corn starch (Tate & Lyle, Decatur, Ill.), was slurried in water at different concentrations shown in Table 2. Sodium lauryl sulfate was added to some of the samples at 3% concentration. Viscosity, solids concentration, and 3M Kit Value were measured as in Example 1. The coating weights and 3M Kit Values in Table 2 are averages of multiple tests.

TABLE 2

| | | Solution | | |
|---|---|---|---|---|
| | | viscosity | coating weight | 3M Kit |
| Composition | % Solids | (cps) | lb/3000 ft² | Value |
| Ethylex 2025 | 26.1 | 302 | 16.5 | 2 |
| Ethylex 2025 | 16.8 | 86 | 11.6 | 2.3 |
| Ethylex 2025 | 15 | 75 | 10.0 | 2 |
| Ethylex 2025 | 15 | 83 | 6 | 0 |
| Ethylex 2025 + SLS | 15 | 108 | 9.9 | 9 |
| Ethylex 2025 + SLS | 15 | 108 | 6.8 | 5.5 |
| Ethylex 2025 + SLS | 15 | 112 | 6.2 | 0 |

### Example 3

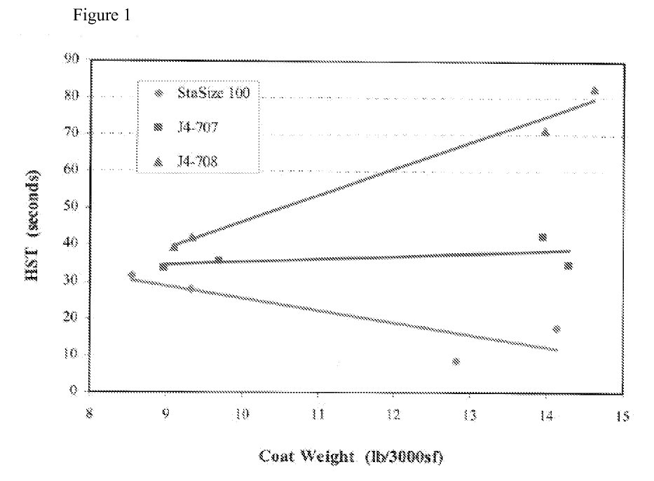

Starch compositions were cooked and then applied to 31 lb base paper (Boise). FIG. 1 shows the effect of coating pick-up (coat weight) and coating composition on water hold-out (Hercules Sizing Test, HST, performed as described in Tappi method T530). The three starch compositions used were StaSize 100 (octenylsuccinate-substituted waxy starch), J4-707 (thinned waxy starch containing 3 solids wt % sodium lauryl sulfate (SLS)), and J4-708 (thinned waxy starch containing 5 solids wt % SLS).

Tables 3-4 show water resistance for coatings of various compositions applied to 31 lb base paper. In Table 3, uncoated paper is used as a control. In Tables 3-4, “CC” is Cleer-Cote 625NB, a thinned waxy starch and “Paraffin” and “Candellia” are wax emulsions containing Paraffin or Candellia wax particles. The viscosity values are for cooked starch pastes at 15% solids, 150° F., on a Brookfield #2 spindle at 100 rpm. As indicated in the tables, HST in Table 3 is the time for reflectance to drop to 60%, whereas in Table 4, it is the time for reflectance to drop to 50%. In HST, the longer the time, the slower the penetration of water into the test specimen.

TABLE 3
Water Resistance of Coated Paper

| | | Coat Weight | HST (sec), 60% |
|---|---|---|---|
| Coating Composition | Viscosity (cps) | (lb/3000 sf) | reflectance |
| CC + 25% Paraffin | 78 | 8.9 | 91.0 |
| CC + 15% Candellia | 93 | 9.0 | 59.6 |
| CC + 3% SLS | 100 | 9.2 | 35.4 |
| CC + 5% SLS | 106 | 9.3 | 43.2 |
| StaSize 100 | 160 | 9.0 | 28.5 |
| CC | 126 | 9.4 | 19.9 |
| uncoated paper | n.a. | 0 | 0.7 |

*CC: Cleer-Cote 625NB, SLS: Sodium lauryl sulfate; Paraffin: Paraffin wax aqueous emulsion; Candellia: Candellia wax aqueous emulsion.

TABLE 4
Water Resistance of Coated Paper

| | | Coat Weight | HST (sec), 50% |
|---|---|---|---|
| Coating Composition | Viscosity (cps) | (lb/3000 sf) | reflectance |
| CC + 25% Paraffin | 76 | 5.3 | 249.9 |
| | | 3.6 | 236.0 |
| CC + 15% Candellia | 96 | 5.9 | 88.2 |
| | | 4.1 | 52.8 |
| CC + 3% SLS | 106 | 5.9 | 29.1 |
| | | 4.2 | 20.1 |
| CC + 5% SLS | 107 | 5.5 | 20.7 |
| | | 3.9 | 16.0 |
| StaSize 100 | 150 | 7.6 | 18.7 |
| | | 5.4 | 15.2 |
| CC | 106 | 5.7 | 20.8 |
| | | 4.2 | 15.2 |

Table 5 shows the effect of defoamer on various coating compositions. The coatings were applied to 25 lb base paper (Boise). J4-708 is Cleer-Cote 625NB thinned waxy starch with 5% SLS. To eliminate pinholing in the coating, the coating pastes were treated to minimize foam formation, e.g., minimal agitation, etc. Defoamers tested were Bubreak 4467 and Ivanhoe FXO-1113A.

The viscosity was measured as described above for Tables 3-4. The Kit value was measured as described above. In the Hot Oil Resistance test, a plate and a felt soaked in a red-dyed vegetable oil and held at 60° C. was placed on the test specimen, which was placed on a sheet of grid paper. The test assembly stood for 2 minutes and was disassembled. The stained area on the grid paper was measured and, if it was less then 0.3% of the surface area of the plate, the specimen was considered a “pass.” Foam volume was measured by adding 250 ml of solution to a 500 ml graduated cylinder with a cap. The cylinder was capped and tumbled end-over-end at about 40 rpm for about 1 min. The liquid volume was subtracted from the volume of liquid+foam to yield the foam volume.

TABLE 5

| | | | | | Foam |
|---|---|---|---|---|---|
| Coating | Viscosity | Coat Weight | Kit | Hot Oil | volume |
| Composition | (cps) | (lb/ream) | value | Resistance | (ml) |
| CC + 5% SLS | 103 | 3.52 | 4.5 | Pass | >300 |
| (Control) | | 2.61 | 0 | Pass | |
| CC + 5% SLS + | 104 | 3.4 | 4.3 | Pass | >200 |
| 0.1% Bubreak | | 2.6 | 0 | Pass | |
| CC + 5% SLS + | 101 | 3.6 | 2 | Pass | 100-200 |
| 0.25% Bubreak | | 2.7 | 0 | Fail | |
| CC + 5% SLS + | 100 | 3.5 | 3.0 | Pass | 100-200 |
| 1% Ivanhoe | | 2.5 | 0 | Pass | |
| CC + 5% SLS + | 95 | 3.3 | 1.0 | Pass | 100-150 |
| 2% Ivanhoe | | 2.0 | 0 | Fail | |
| CC + 5% SLS + | 101 | 3.3 | 3.5 | Pass | <50 |
| 1% Ivanhoe 1% + | | 1.9 | 0 | Pass | |
| 0.2% Bubreak | | | | | |
| CC + 4% SLS + | 100 | 2.9 | 2.5 | Pass | <25 |
| 1% Ivenhoe + | | 1.7 | 0 | Pass | |
| 0.2% Bubreak | | | | | |

* CC: Cleer-Cote 625NB;
SLS: Sodium lauryl sulfate;
Bubreak: Bubreak 4467;
Ivanhoe: Ivanhoe XFO-1113A.

The results in Table 5 show that 1% Ivanhoe FXO-1113A silica-based defoamer, in combination with Bubreak 4467 silicone defoamer, provides excellent foam control with minimal impact on grease holdout.

We submit an efficient way to use this combination is by adding Ivanhoe FXO-1113A into the formulation at the very beginning, while spraying Bubreak 4467 on the top of the foam during coating processing.

### Example 4

### Defoamer Selection

There are two main functions for an efficient defoamer: (1) prevent foam generation, and (2) eliminate foam generated. The material with dominantly function “1” was usually mixed into formulation at the beginning and also called “Antifoam”. When an efficient antifoam was included in a formulation, no foam was seen. While that mainly with function “2” was used after foam generation by directly applied on the top of foam, being classified as “Defoamer.”

However, there is no restricted nomination for the product classification. For example, a “Silicone Antifoam” was used as a defoamer in most cases. In respect to the materials we used, we refer to Ivanhoe XFO-1113A as an antifoam and Bubreak 4467 as a defoamer. However, as shown in Example 3, the presence of Ivanhoe enhanced the defoaming efficiency of Bubreak. Thus, we also refer to the Ivanhoe/Bubreak combination as a defoamer because it works synergistically.

A screening was carried to identify other candidate antifoams or defoamers. Seven candidates were selected as representatives of 20 different products based on material type, composition, and morphology. Bubreak series are the products of Buckman. FG-10 is a silicone antifoam from Dow Corning (Midland, Mich.). Ivanhoe FXO-1113A is a product of Ivanhoe Industries, Inc. Table 6 summarizes the characteristics of these defoamers.

TABLE 6
Selected Defoamer Products

| Product | Type | Form | Manufacturer |
|---|---|---|---|
| Bubreak 4452 | Glycol Ester Concentrate | Solution | Buckman |
| (Control) | | | |
| Bubreak 4418 | Glycol Concentrate | Solution | |
| Bubreak 4421 | Water Based Glycol | Dispersion | |
| Bubreak 4467 | Water Extended Silica, | Dispersion | |
| | Oil, Silicone | | |
| Bubreak 4454 | Oil Based Silica and Glycol | Dispersion | |
| FG-10 | Silicone antifoam | Dispersion | Dow Corning |
| Ivanhoe | Silica and unknown, | Powder | Ivanhoe |
| FXO-1113A | Powder | | |

These seven candidates were compared according to the following procedure: A half gram of individual defoamer was added into 9.5 grams of DI water in a 20-ml glass vial. All seven vials were fixed in a rack and manually shaken for 30 seconds. The relative foam volume was recorded relative to Bubreak 4452 as control “1×”. The time for foam disappearance was also recorded. If the foam remained after 5 minutes, the remaining foam volume was recorded instead. The results are summarized in Table 7.

TABLE 7
Defoaming Efficiency of Selected Products

| | Bubreak | Bubreak | Bubreak | Bubreak | Bubreak | Bubreak | | |
|---|---|---|---|---|---|---|---|---|
| Defoamer ID | 4452 | 4418 | 4421 | 4467 | 4419 | 4454 | FG-10 | Ivanhoe |
| Related | 1× | 2× | 3× | 0 | minimal | minimal | 0 | 0.5× |
| Foam | | | | | | | | |
| Volume | | | | | | | | |
| Bubble | — | — | — | 0 | 30 | 30 | 0 | 20 |
| disappear | | | | | | | | |
| (sec) | | | | | | | | |
| Bubble | 0.5× | 1.5× | 2.5× | — | — | — | — | — |
| remain after | | | | | | | | |
| 5′ | | | | | | | | |
| Defoaming | Out | Out | Out | Best | Fine | Fine | Best | Fine |
| efficiency | | | | | | | | |

* 2×: Two times of Bubreak 4452's volume

Based on these results, Bubreak 4467 and Ivanhoe combination was selected, although other defoamers or combinations of defoamers, antifoamers, etc. could be used.

It should be noted that Bubreak 4467 is a liquid dispersion of multiple phase structure and hydrophobic continuous phase. As a result, it would be expected to not work well in the presence of a high level of sodium lauryl sulfate, a very efficient emulsifier. Also, mixing a small amount of a liquid product into a powder product would make blending more difficult to process. Therefore, we conclude that Bubreak 4467 would optimally work best when added on the top of foam to eliminate the foam generated during processing.

It should also be noted that Ivanhoe XFO-1113A is a powder consisting of silica particles and unknown solid hydrophobic material or surfactant. Its particle size is roughly in the range of 3-20 μm in diameter. It did not work as well as Bubreak 4467 in the case of pure water. But, it is expected to maintain its integrity better in the presence of SLS and to depress the foam generation during the early stage of processing. Thus, a combination of Bubreak 4467 and Ivanhoe XFO-1113A was selected for study in Examples 2-3 to determine the right composition, dosage, and processing.

The preceding description is not intended to be an exhaustive list of all embodiments of the invention. Persons skilled in this field will recognize that modifications could be made to the specific embodiments that are described herein, that would be within the scope of the following claims.

1. A composition, comprising:
starch; and
at least one additional component selected from the group consisting of (a) amphiphilic surfactants, (b) particulate emulsions, and (c) combinations thereof,
wherein, if the composition comprises one or more amphiphilic surfactants, the weight ratio of total surfactant to starch is from about 0.005:1 to about 0.25:1 and, if the composition comprises one or more particulate emulsions, the weight ratio of total particulate emulsion to starch is from about 0.005:1 to about 0.429:1.

2. The composition of claim 1, wherein the starch is a thinned starch.

3. The composition of claim 1, wherein the starch is unsubstituted.

4. The composition of claim 1, wherein the starch is waxy starch.

5. The composition of claim 1, wherein the surfactant comprises:
a sulfate, phosphate, or carboxylate moiety; and
an alkyl or alkenyl moiety having 4-24 carbons or an aromatic moiety having 6-24 carbons.

6. The composition of claim 5, wherein the surfactant is sodium lauryl sulfate.

7. The composition of claim 1, wherein the particulate emulsion comprises paraffin wax.

8. The composition of claim 1, further comprising a defoamer.

9. The composition of claim 1, further comprising a polymer selected from the group consisting of alginate, sodium carboxymethyl cellulose (CMC), and gelatin.

10. The composition of claim 1, further comprising a sizing agent.

11. The composition of claim 1, further comprising water, wherein the composition comprises from about 3 wt % to about 40 wt % solids.

12. The composition of claim 11, wherein the composition comprises from about 0.5 wt % to about 20 wt % surfactant.

13. The composition of claim 12, wherein the composition comprises from about 2 wt % to about 10 wt % surfactant.

14. The composition of claim 11, wherein the composition comprises from about 0.5 wt % to about 30 wt % paraffin wax.

15. A paper product, comprising:
a substrate comprising paper and having a first surface and a second surface; and
a coating applied to at least part of the first surface of the substrate, wherein the coating comprises starch and at least one additional component selected from the group consisting of (a) amphiphilic surfactants, (b) particulate emulsions, and (c) combinations thereof.

16. The paper product of claim 15, wherein the coating comprises both an amphiphilic surfactant and a particulate emulsion.

17. The paper product of claim 16, wherein the coating comprises sodium lauryl sulfate and paraffin wax.

18. The paper product of claim 15, wherein the starch is a thinned starch.

19. The paper product of claim 15, wherein the starch is unsubstituted.

20. The paper product of claim 15, wherein the starch is waxy starch.

21. The paper product of claim 15, wherein the surfactant comprises:
a sulfate, phosphate, or carboxylate moiety; and
an alkyl or alkenyl moiety having 4-24 carbons or an aromatic moiety having 6-24 carbons.

22. The paper product of claim 21, wherein the surfactant is sodium lauryl sulfate.

23. The paper product of claim 15, wherein the particulate emulsion comprises paraffin wax.

24. The paper product of claim 15, further comprising a defoamer.

25. The paper product of claim 15, further comprising alginate.

26. The paper product of claim 15, further comprising a sizing agent.

27. The paper product of claim 15, wherein the substrate is paperboard.

28. The paper product of claim 15, wherein the paper product is in the form of a package that contains an oily or greasy food and the coating stands between the oily or greasy food and the substrate.

29. The paper product of claim 28, wherein the oily or greasy food is selected from the group consisting of pet food, microwaveable popcorn, pizza, fried potatoes, fried vegetables, pastries, chocolate bars, and foods containing an oil-based sauce.

30. The paper product of claim 15, further comprising a topcoat applied to at least part of the coating, wherein the topcoat is selected from the group consisting of (1) a silicone-containing film for release, (2) an oil-grease resistant film for optimum performance, (3) a water resistant film, and (4) a smooth and ink-adsorbing film for high quality printing.
